(19) United States
(12) Patent Application Publication
(10) Pub. No.: US 2019/0204416 A1
(43) Pub. Date: Jul. 4, 2019

(54) TARGET OBJECT DETECTING DEVICE, METHOD OF DETECTING A TARGET OBJECT AND COMPUTER READABLE MEDIUM

(71) Applicant: Furuno Electric Co., Ltd., Nishinomiya (JP)

(72) Inventors: Katsuyuki Yanagi, Nishinomiya (JP); Shinsuke Inoue, Nishinomiya (JP); Katsuo Yamada, Nishinomiya (JP)

(21) Appl. No.: 16/234,522

(22) Filed: Dec. 27, 2018

(30) Foreign Application Priority Data
Dec. 28, 2017 (JP) 2017-254163

(51) Int. Cl. G01S 7/41; G01S 7/22; G01S 13/93; G01S 13/72

(52) U.S. Cl. CPC G01S 7/417; G01S 13/723; G01S 13/9307; G01S 7/22

(57) ABSTRACT

A target object detecting device is provided, which may include an acquisition part, a generation part, and a detecting part. The acquisition part may acquire echo signals from target objects around a ship. The generation part may generate a first echo image based on the echo signals. The detecting part may input the first echo image into a model built by a program implementing a machine learning algorithm, and may detect a first target object that is a target object other than a ship corresponding to the model, based on an output from the model.

### CROSS-REFERENCE TO RELATED APPLICATION(S)

This application claims priority under 35 U.S.C. § 119 to Japanese Patent Application No. 2017-254163, which was filed on Dec. 28, 2017, the entire disclosure of which is hereby incorporated by reference.

### TECHNICAL FIELD

The present disclosure relates to a device, method, and program which detect a target object around a ship, as well as a device, method, and program which trains a model used for detecting the target object around the ship.

### BACKGROUND

Radar devices mounted on a ship display a radar image indicating target objects around the ship based on echo signals corresponding to radio waves emitted from a radar antenna. The target objects displayed in the radar image are typically other ships. Sailors visually check the radar image where other ships are displayed to grasp an exact situation around the ship, thereby enabling safe cruising. A suitable gain adjustment is made in signal processing for generating the radar image from the echo signals so that the images of other ships are displayed clearly. Since echo signals caused by sea surface reflections, and rain and/or snow clutter may become noise in the ship images, a further adjustment of the signals is performed to remove the noise.

Here, the target objects needed to be observed by the radar device are not only other ships. For example, images of land and banks may also be useful information for grasping the situation around the ship. In addition, there is also a need for observation of a situation of birds. Although there are various reasons for detecting the birds, for example, if a flock of birds can be identified, the existence of a school of fish therebelow can naturally be predicted.

Generally, radar devices for ships are mainly built to display the image of other ships around the ship, and therefore, images of target objects other than ships are often filtered out as noise. Particularly, since the echo signals from a bird, a small rock, a current rip, ice, rain, clouds, SART (Search And Rescue Transponder), etc. which are generally weak compared with the echo signal of a ship, these features are difficult to clearly be identified in the radar image. Therefore, it is still difficult to accurately detect various target objects other than ships in the radar image, and it can be said that such technologies are still in a developmental stage. Moreover, without limiting to radar devices, a similar demand for accurately detecting various target objects exists in fields of other target object detecting devices, such as fish finders and sonar.

### SUMMARY

One purpose of the present disclosure is to provide a device, method, and program which can accurately detect various target objects around a ship, and a device, method, and program which train a model used for accurately detecting various target objects around the ship.

According to one aspect of the present disclosure, a target object detecting device is provided, which may include an acquisition part, a generation part, and a detecting part. The acquisition part may acquire echo signals from target objects around a ship. The generation part may generate a first echo image based on the echo signals. The detecting part may input the first echo image into a model built by a program that implements a machine learning algorithm, and may detect a first target object that is a target object other than a ship corresponding to the model, based on an output from the model.

According to this configuration, the first echo image may be generated based on the echo signal from the target object. The first echo image may be inputted into the model built by machine learning, and based on the output from this model, the first target object other than a ship may be accurately detected. Thus, various target objects around the ship (other than ships) may accurately be detected. In addition, according to another aspect of the present disclosure, a model suitable for detecting the target objects other than ships may be built.

### BRIEF DESCRIPTION OF DRAWINGS

The present disclosure is illustrated by way of example and not by way of limitation in the figures of the accompanying drawings, in which like reference numerals indicate like elements and in which:

FIG. 1 is a view illustrating the entire configuration of a radar device which is a target object detecting device according to one embodiment of the present disclosure;

FIG. 2 is a view schematically illustrating an appearance of a radar indicator;

FIG. 3 is a view illustrating one example of a radar screen including a radar image in a normal mode;

FIG. 4 is a view illustrating one example of the radar screen including a radar image in a bird mode;

FIG. 5A is a view illustrating one example of the radar image in the normal mode, and FIG. 5B is a view illustrating one example of the radar image in the bird mode based on the same echo signals as the radar image of FIG. 5A;

FIG. 6 is a view illustrating another example of the radar image in the bird mode;

FIG. 7 is an enlarged view of images of a ship and birds in the bird mode;

FIG. 8 is a view illustrating the entire configuration of a learning device according to one embodiment of the present disclosure;

FIG. 9 is a flowchart illustrating a flow of tracking of a flock of birds;

FIG. 10 is a conceptual view illustrating the tracking with a αβ tracking filter;

FIG. 11A illustrates one example of a display output of information indicating that a flock of birds exists, and FIG. 11B illustrates another example of the display output of the information indicating that the flock of birds exists;

FIG. 12 is a flowchart illustrating a flow of displaying the existence of the flock of birds; and

FIG. 13 is a view illustrating the entire configuration of a target object detecting device according to a modification of the present disclosure.

### DETAILED DESCRIPTION

Hereinafter, a target object detecting device, method, and program, and a learning device, method, and program will be described with reference to the accompanying drawings according to one embodiment of the present disclosure.

### <1. Configuration of Radar Device (Target Object Detecting Device)>

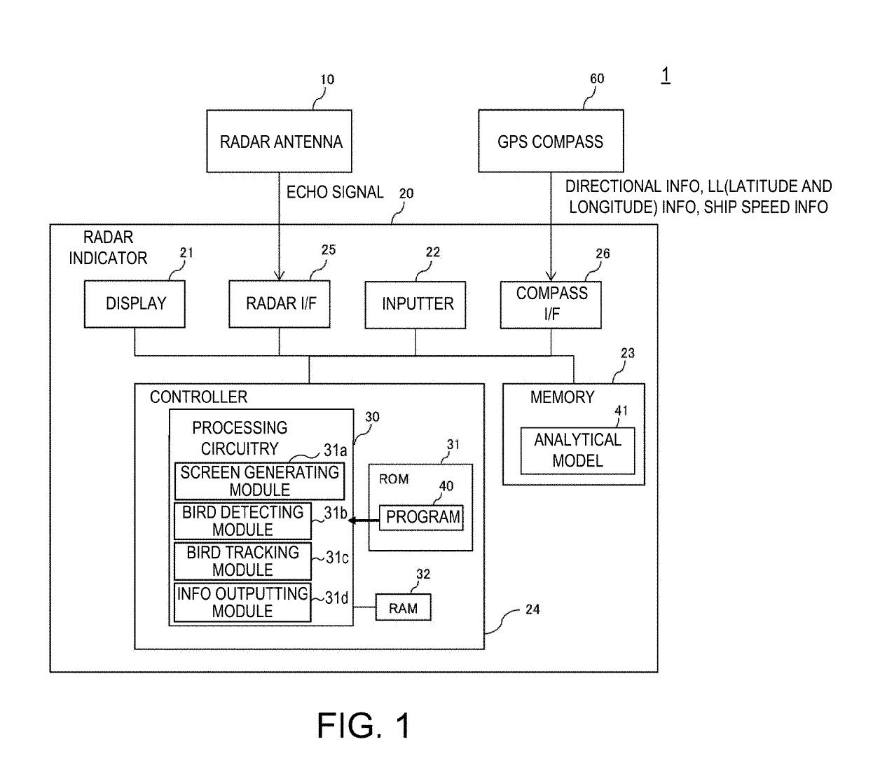

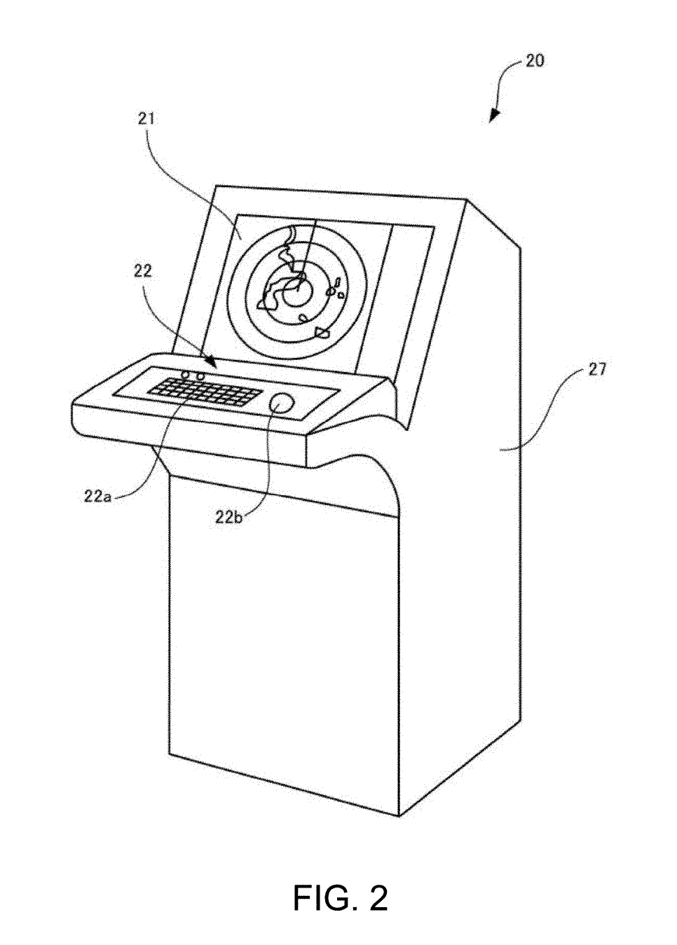

FIG. 1 illustrates the entire configuration of a radar device 1 as the target object detecting device according to one embodiment. The radar device 1 may be a device which assists cruising of a ship, and may be mounted on the ship. Note that the ship provided with the target object detecting device according the present disclosure is herein referred to as “the ship,” to be distinguished from other ships. Note that the present disclosure may be applied to ships which typically travel on water or sea and are referred to as surface ships, and may also be applied to other types of ships, which may include boats, dinghies, watercraft, and vessels. Further, the present disclosure may also be applied, if applicable, to submarines, aircrafts, and spaceships, as well as any types of vehicles which travel on the ground, such as automobiles, motorcycles, and ATVs.

The radar device 1 may include a radar antenna 10, and a radar indicator 20 connected to the radar antenna 10. The radar antenna 10 may emit a pulse-shaped radio wave, and receive an echo signal which is a reflected wave of the emitted radio wave at a target object. The radar antenna 10 may repeatedly transmit the radio wave and receive the corresponding echo signal, while swiveling in a horizontal surface, thereby scanning 360° around the ship. The echo signal from the target object, which is received by the radar antenna 10, may be sequentially converted into digital data by an A/D converter (not illustrated), and the converted echo signal may be sequentially outputted to the radar indicator 20.

The radar indicator 20 may be connected to a GPS compass 60 which is also mounted on the ship. The GPS compass 60 may measure, at a given time interval, information on a bow direction or heading of the ship (hereinafter, is referred to as “the directional information”), information on latitude and longitude of the ship (hereinafter, is referred to as “the LL information”), and information on a speed of the ship. The GPS compass 60 may sequentially output the information to the radar indicator 20.

FIG. 2 illustrates an appearance of the radar indicator 20. The radar indicator 20 may be an apparatus which is operated by a user, and it may have a case 27 as illustrated in this figure. The radar indicator 20 may be provided with a display part (which is also referred to as a display) 21 and an input part (which is also referred to as an inputter) 22 at a front side of the case 27 where the user stands. The radar indicator 20 may also include a radar interface part (which is also referred to as a radar interface) 25, a memory part (which is also referred to as a memory) 23, a control part (which is also referred to as a controller) 24, and a compass interface part (which is also referred to as a compass interface) 26, as illustrated in FIG. 1. The radar interface part 25 may be a port for communicating with the radar antenna 10, and may receive the echo signals outputted from the radar antenna 10. The compass interface part 26 may be a port for communicating with the GPS compass 60, and receive the directional information, the LL information, and the ship speed information outputted from the GPS compass 60. The memory part 23 and the control part 24 may be accommodated in the case 27. These parts 21-26 may be communicatably connected with each other via bus lines.

The display part 21 may be a user interface which displays a screen for presenting a variety of information to the user, and in this embodiment, is comprised of a liquid crystal display. The input part 22 may be a user interface which receives various operations to the radar indicator 20 from the user, and in this embodiment, is comprised of a keyboard 22a and a trackball 22b. The input part 22 may also include a touch panel laminated on the display part 21.

The memory part 23 may be a nonvolatile storage device comprised of a hard-disk drive and/or a flash memory. The memory part 23 may store an analytical model 41 built by machine learning. Details of the analytical model 41 will be described later. The control part 24 may be comprised of a CPU 30, a ROM 31, and a RAM 32. The ROM 31 may store a computer program 40 which causes the CPU 30 to perform various operations. The CPU 30 may read and executes the program 40 in the ROM 31 to virtually operate as a screen generating module 31a, a bird detecting module 31b, a bird tracking module 31c, and an information outputting module 31d. Details of operations of these parts 31a-31d will be described later. Note that the program 40 may be stored not in the ROM 31 but in the memory part 23, or distributedly stored in both the memory part 23 and the ROM 31.

### <2. Operation of Radar Device>

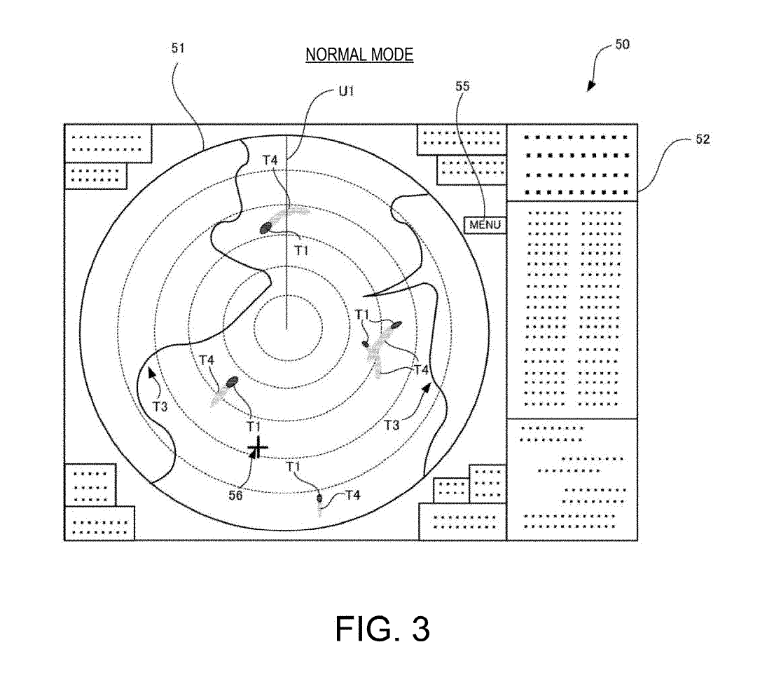

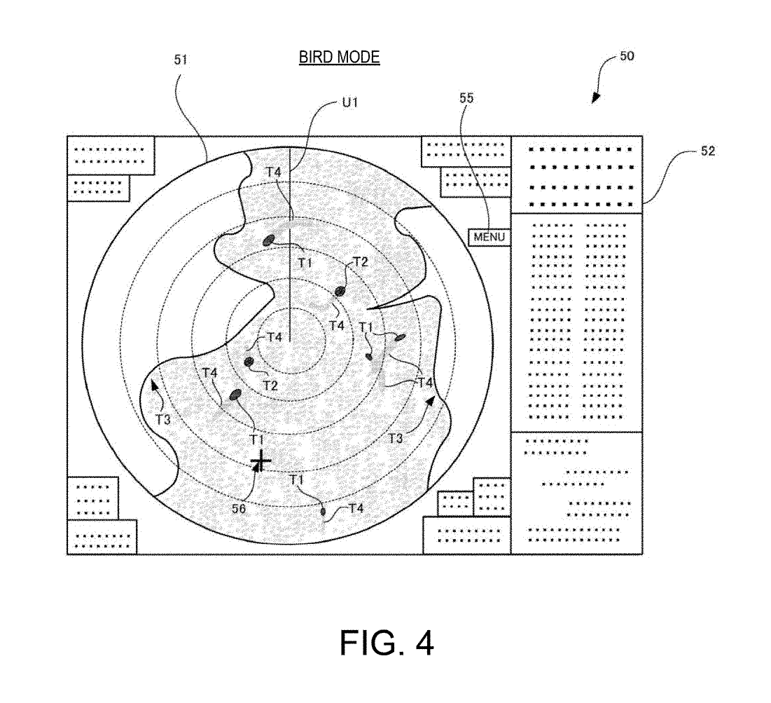

Next, various processings executed by the radar device 1 are described. The radar indicator 20 included in the radar device 1 can execute a display processing and a bird detection processing. The display processing may be to generate a radar screen 50 (see FIGS. 3 and 4) which indicates a situation of the ship and one or more target objects around the ship based on the echo signals acquired by the radar interface part 25, and display the screen on the display part 21. On the radar screen 50, an image 51 which indicates the echo image of the target objects around the ship (hereinafter, referred to as “the radar image”) may be displayed. The bird detection processing may be to detect based on the radar image 51 birds which exist around the ship, and more specifically, a flock of birds formed by birds making a group. Below, details of the display processing and the bird detection processing are described.

### <2-1. Display Processing>

The display processing may be performed mainly by the screen generating module 31a. The screen generating module 31a may sequentially acquire the echo signals through the radar interface part 25, and then generate the radar screen 50 (see FIGS. 3 and 4) based on the echo signals. More specifically, radar information on a distance, a direction, etc. to the target objects, such as other ships and flocks of birds, with respect to the ship may be calculated by analyzing the echo signals. The screen generating module 31a may generate the radar image 51 which indicates the echo image of the target objects around the ship based on the radar information. The radar image 51 may form a map in which locations of the target objects which exist in an area around the ship are indicated in a map manner. As illustrated in FIGS. 3 and 4, the radar screen 50 may have a rectangular shape as a whole, and the radar image 51 having a circular shape is disposed on the radar screen 50. Here, one radar image 51 is generated from the echo signals for one rotation of the radar antenna 10 (scanning data). Each time new echo signals are acquired, the radar image 51 may be updated based on the new echo signals. Therefore, the user may grasp the situation around the ship on real time, by watching the radar image 51.

The screen generating module 31a may display, in addition to the radar image 51, an information display area 52 on the radar screen 50. In the example of FIGS. 3 and 4, the information display area 52 may be located mainly along the right end of the radar screen 50 so as not to overlap with the radar image 51. Variety of information for assisting a cruise of the ship, for example, information on the ship and information of the environment around the ship are displayed in the information display area 52. The information on the ship includes, for example, the LL information on the ship, the directional information, and the ship speed information. The environmental information includes, for example, information on water temperature, water depth, wind direction, and wind velocity. Note that a part of the information displayed in the information display area 52 may be calculated based on information acquired from apparatuses, such as various measuring instruments, connected to the radar indicator 20 (e.g., the GPS compass 60).

A main menu button 55 may be displayed on the radar screen 50. The main menu button 55 may desirably be disposed so as not to overlap with the radar image 51. A cursor 56 is also displayed on the radar screen 50. The cursor 56 may be freely moved within the radar screen 50 by the user operating the input part 22. In this embodiment, when the user performs a given operation by using the input part 22 while the cursor 56 is located on the main menu button 55, the main menu button 55 may open hierarchically to show various sub menu buttons. The sub menu buttons may desirably be disposed so as not to overlap with the radar image 51. The user may execute a desired function implemented in the radar indicator 20 by operating the input part 22 and selecting a suitable one of the sub menu buttons.

There may be a normal mode (auto mode) and a bird mode in the radar image 51. The user may arbitrarily switch the mode between the normal mode and the bird mode by performing a given operation through the input part 22. The radar image 51 in the normal mode may be an echo image generated mainly for the purpose of clearly indicating images T1 of other ships. On the other hand, the radar image 51 in the bird mode may be an echo image generated for the purpose of indicating images T2 of flocks of birds which return weak echo signals as compared with other ships. The normal mode is typically used for observing movements of other ships while the ship is traveling to avoid collisions with other ships and grasping the locations of sister ships etc. On the other hand, the bird mode is typically used for finding out a flock of birds, which may lead to a school of fish normally existing below a flock of birds.

FIG. 3 illustrates one example of the radar screen 50 in the normal mode, and FIG. 4 illustrates one example of the radar screen 50 in the bird mode. Note that the radio wave from the radar antenna 10 may be reflected not only by other ships and flocks of birds but by various target objects, such as land and buoys. Therefore, on the radar image 51, images T3 of land etc. may also be displayed, other than the images T1 of other ships and the images T2 of flocks of birds.

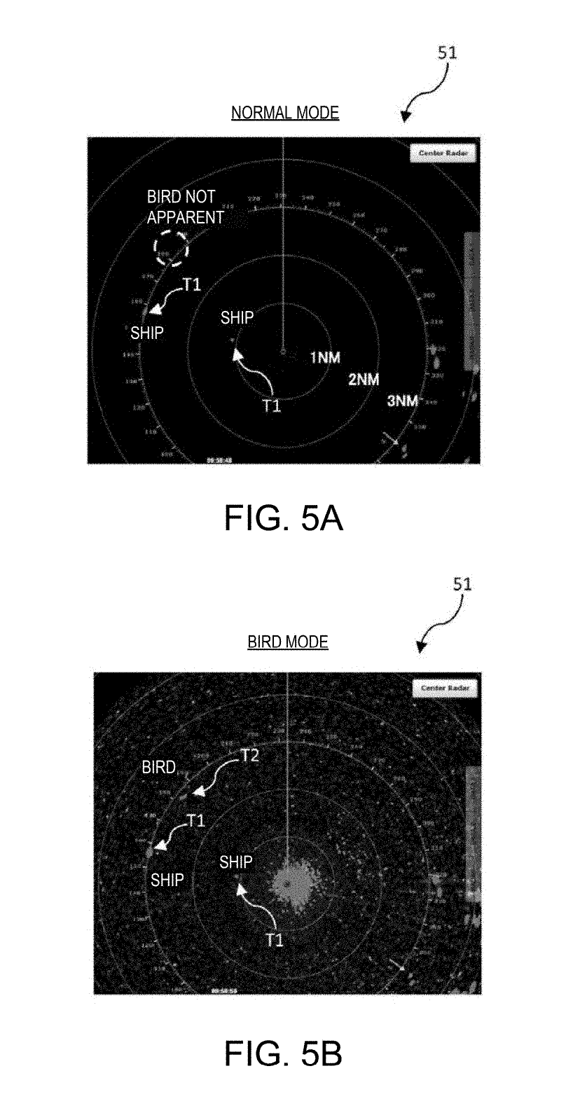

FIG. 5A illustrates one example of the radar image 51 in the normal mode, and FIG. 5B illustrates one example of the radar image 51 in the bird mode based on the same echo signals as the radar image 51 in FIG. 5A. As can be seen in these figures, in the bird mode, noise may be entirely apparent as compared with the normal mode. However, in the bird mode, the image T2 of a flock of birds, which is hardly apparent by the normal mode, may be caught. On the other hand, in the normal mode, since noise is entirely less, the images T1 of other ships may be indicated more clearly than in the bird mode.

The screen generating module 31a may adjust the echo signals according to the currently-selected mode, either the normal mode or the bird mode, when generating the radar image 51. In the bird mode, the screen generating module 31a may adjust the echo signals so that the reflected waves at flocks of birds, which are weaker than the reflected waves at other ships, may be caught, and then generate the radar image 51 based on the adjusted echo signals. The method of adjusting the echo signals includes, for example, an adjustment of a gain (sensitivity) and a removal of the noise caused by sea surface reflections, and rain and snow clutters. In the bird mode, the gain may be raised as compared with the normal mode, in order to capture the images T2 of flocks of birds based on the echo signals weaker than the images T1 of other ships. In addition, in the bird mode, levels of the removal of the sea surface reflections and the removal of the rain and snow clutter may be lowered as compared with the normal mode so that the images of flocks of birds will not disappear by an excessive noise removal. Moreover, in the bird mode, it may be desirable not to perform the removal of the rain and snow clutter.

Moreover, the radar image 51 may have a relative-motion mode and a true-motion mode. The relative-motion mode may be a mode in which the location of the ship is always set at a fixed location in the radar image 51 (typically, at the center of the radar image 51). On the other hand, the true-motion mode may be a mode in which the locations of stationary target objects, such as land, are fixed in the radar image 51. The user may switch the mode between the relative-motion mode and the true-motion mode by performing a given operation through the input part 22.

The screen generating module 31a may also display a heading bright line U1 on the radar image 51. The heading bright line U1 may be displayed on the radar image 51 by a line extending in the bow direction of the ship from the current location of the ship to the perimeter of the radar image 51. That is, an inner end of the heading bright line U1 may represent the current location of the ship. In the true-motion mode, the inner end of the heading bright line U1, i.e., the location of the ship, may be located at various locations on the radar image 51. On the other hand, in the relative-motion mode, the inner end of the heading bright line U1 may always be located at the fixed location, such as the center on the radar image 51.

The screen generating module 31a may also display on the radar image 51 the images T4 of echo trails of target objects, such as other ships and flocks of birds. For example, the images T4 of the echo trails of target objects may be formed by superimposing the echo images of target objects, such as the images T1-T3 indicated in the past radar images 51, on the latest radar image 51. The user may switch a display setting of the images T4 of the echo trails between “Display” and “Not Displaying” by performing a given operation through the input part 22.

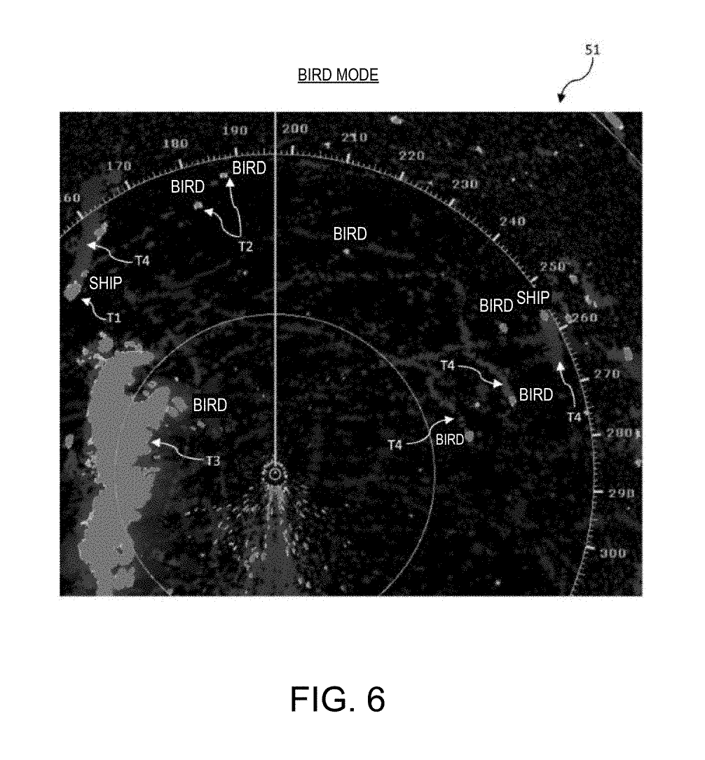

FIG. 6 illustrates another example of the radar image 51 in the bird mode. As illustrated in this figure, the images T4 of the echo trails of ships generally appear comparatively clearly on the radar image 51 not only in the normal mode but also in the bird mode. On the other hand, the images T4 of echo trails of birds, particularly flocks of birds may appear intermittently, and may be changed suddenly in the course, and/or wind. In order to more accurately capture such features of birds, it may be important to observe the absolute motion of the birds with respect to a stationary point, such as land, instead of observing the relative motion of the birds with respect to the ship. Therefore, the radar image 51 in the bird mode may desirably be an echo image obtained in the true-motion mode (hereinafter, referred to as “the true echo trail image”). Note that, even in the relative-motion mode, a similar echo image to the true echo trail image may be obtained by using the ship speed information acquired from the GPS compass 60.

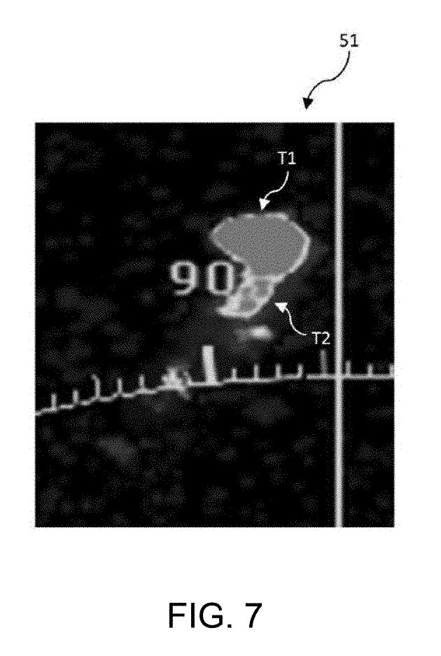

Generally, since birds fly higher and lower between a water surface and above the sky, a variation may be caused in the intensity of the echo signal of birds, particularly a flock of birds, resulting in a variation in the echo image. FIG. 7 is an enlarged view of the image T1 of another ship and the image T2 of a flock of birds in the bird mode.

As described above, the image T2 of a flock of birds and the image T4 of the echo trail may indicate different features from the image T1 of a ship and the image T4 of an echo trail. Therefore, the user may know the existence and the locations of the flocks of birds around the ship by finding out on the radar image 51 in the bird mode, the images T2 of the flocks of birds and the images T4 of the echo trails having the above features.

### <2-2. Bird Detection Processing>

Next, based on the radar image 51, the bird detection processing in which flocks of birds are automatically detected is described. In the bird detection processing, flocks of birds may be detected based on the analytical model 41 which uses the radar image 51 as an input and uses information indicative of the existence of the flocks of birds as an output. The radar image 51 used in the bird detection processing of this embodiment may be the radar image 51 in the bird mode. The analytical model 41 may be built by a program executing a machine learning algorithm, typically carried out beforehand, and information which defines the analytical model 41 may be stored in the memory part 23. Below, after describing a machine learning process of the analytical model 41, details of a flow of the bird detection processing will be described.

### <2-2-1. Learning Process of Analytical Model>

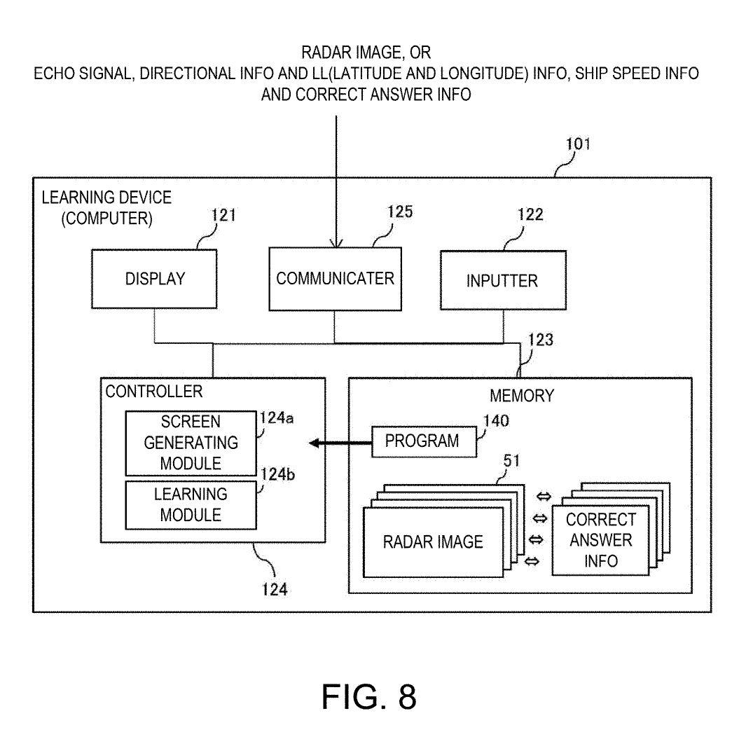

FIG. 8 illustrates the entire configuration of a learning device 101. The training process of the analytical model 41 may be independent from a scene where the analytical model 41 is used after training. Therefore, in this embodiment, the training of the analytical model 41 may be performed not in the radar device 1 but mainly in the learning device 101; however, the learning function of a learning module 131c (described later) may of course be implemented in the radar device 1.

The learning device 101 may be a general-purpose computer as hardware, and include a display part 121, an input part 122, a memory part 123, a control part 124, and a communication part 125. These parts 121-125 may be communicatably connected with each other through bus lines.

The display part 121 may be a user interface which displays a screen for indicating a variety of information to the user, and may be comprised of a liquid crystal display. The input part 122 may be a user interface which receives various operations to the learning device 101 from the user, and may be comprised of a mouse, a keyboard, a touch panel, etc. The memory part 123 may be a nonvolatile storage device comprised of a hard disk and/or a flash memory. The control part 124 may be comprised of a CPU, a ROM, and a RAM, and read and execute a computer program 140 stored in the memory part 123 to virtually operate as a screen generating module 124a and a learning module 124b.

The communication part 125 may be a port for communicating with external apparatuses, and receives many radar images 51 in the bird mode from a device like the radar indicator 20. Alternatively, the communication part 125 may receive the echo signals, and if needed, the directional information, the LL information, and the ship speed information, from devices like the radar antenna 10 and the GPS compass 60. In the latter case, the screen generating module 124a may create the radar image 51 in the bird mode based on the echo signals, and if needed, the directional information, the LL information, and the ship speed information, by a similar method to the screen generating module 31a. The radar image 51 which is acquired by the communication part 125 or is generated by the screen generating module 124a may be stored in the memory part 123.

In the learning process, the echo signals when various target objects, such as other ships, rocks, current rips, ice, rain, clouds, and SART, exist in addition to flocks of birds, and if needed, the directional information, the LL information, and the ship speed information, or the radar image 51 based on the echo signals and the information, may be inputted into the communication part 125. In addition, information indicative of types of target objects caught in the echo signals or the radar image 51 (hereinafter, referred to as “the correct answer information”) may be inputted to the communication part 125. Alternatively, the user may input the correct answer information through the input part 122. The correct answer information may indicate the location and type of each object. The inputted correct answer information may be stored in the memory part 123 so as to be associated with the radar image 51. As one particular example, during the training phase the radar indicator 20 may be configured as a data capture device on board the ship. The radar indicator 20 captures radar signals of various objects and stores them as a set of successively captured radar images. During the training phase an initial filtering is performed on the radar images to identify objects (e.g., “blobs” appearing in the image) that are of an appropriate size, position, shape, and/or intensity to be candidate objects that might be determined to be birds. Acceptable ranges of values for these parameters are set according to a corresponding function for each parameter that varies based on the distance to the blob from the ship, since these parameters will vary with the distance to the imaged object, and blobs that are not within the acceptable ranges are filtered out, leaving only candidate objects remaining. Once the candidate objects are determined at an imaging time (T1), in the training phase, human observation is then performed. For example, the ship is then steered toward the real-world location of a candidate object in the radar image, and human observation is performed at observation time (To) to confirm whether or not birds are present in the identified location. If birds are present, then the corresponding blob that was identified as a candidate object is tagged with appropriate label data in the stored radar image captured at imaging time (T1). The label data may include a confirmation that birds were present, a number of the birds in the observed flock, a species of the birds, and an activity of the birds (feeding, resting on the surface of the water, etc.), for example. It will be appreciated that the present disclosure is particularly useful for identifying birds that are out of sight of the ship, for example, at distances greater than 2 or 3 kilometers away. At such distances, the ship may take a while to arrive at the candidate object location for observation. Thus, a time lag may result between imaging time (T1) and observation time (To). This can be acceptable in the present application because of particular use to fishing ships is information on the presence of flocks of birds that are relatively stationary and engaged in feeding activity on large schools of fish. To cut the time lag down during the training phase, for example, remote observation ships or aircraft, such as drones, may be used to confirm the presence of birds via direct human observation or indirect observations through cameras. As a result of such a training phase, a tagged training data set is produced that contains radar images that are tagged with metadata in the form of the labeling information discussed above, for confirmed bird sightings. This tagged metadata is referred to herein as the correct answer information.

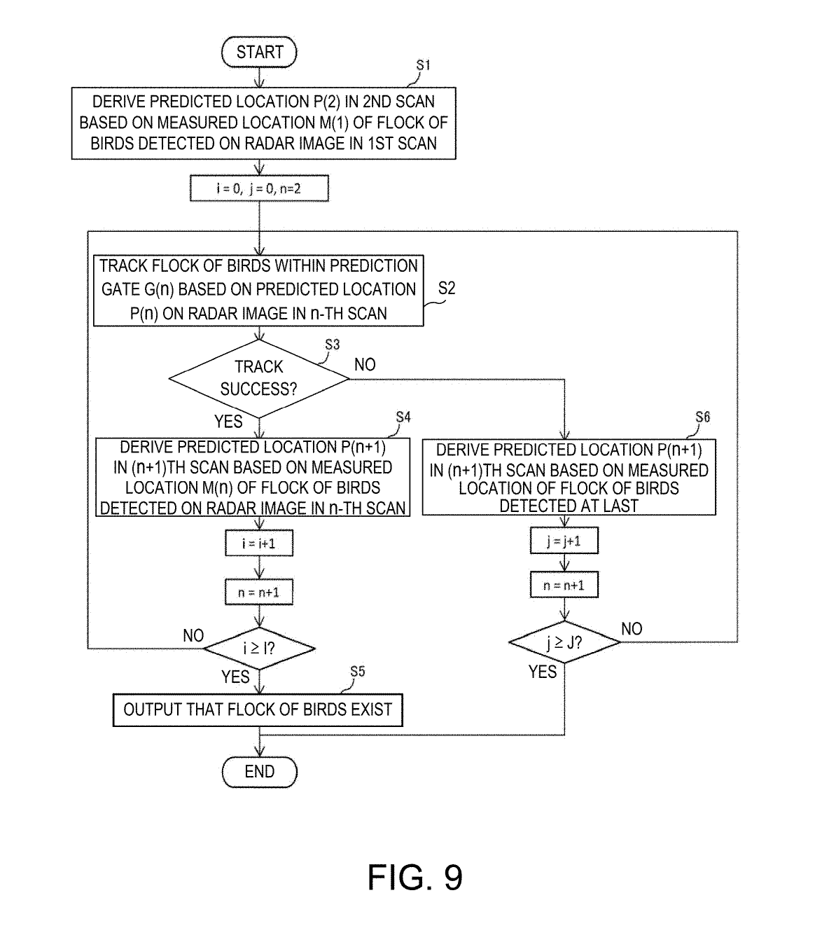

It will also be appreciated that at such distances, a flock of birds will often appear in the radar images as a unitary or congealed blob representing the flock rather than a pattern of individual dots for each bird. For this reason, discriminating the flock from other objects can be difficult, since the pattern of echoes of individual birds cannot be seen in the radar image. Further, as discussed elsewhere herein, the candidate blob for a flock of birds may disappear or fade in successive images. This is due to the behavior of the flock as it flies around and dives in unison toward its prey in the ocean. As the flock approaches the ocean surface, the radar echoes from the flock become weaker, due interference by waves at the surface of the sea, for example. As the flock rises into the sky, the radar echoes typically become stronger. In frames in which the radar echo from a flock is weak, the prefiltering discussed above for the various parameters than are used to identify candidate blobs will also filter out the weakly reflected radar echoes of the flock, resulting in a false negative. In a later frame, as the flock rises after feeding in the same general latitudinal and longitudinal position, the echoes will strengthen from the flock and it will be included in the candidate blobs once again. The processing shown and described below in relation to FIG. 9 serves to help identify birds as birds from among a plurality of candidate blobs based on such variance over time in the strength of the echoes and identification of the blob as a candidate in such prefiltering operations based on this variance.

A set of the radar image 51 and the correct answer information may serve as training data for training the analytical model 41. The analytical model 41 of this embodiment may be a convolutional neural network. As one specific example, the AlexNet convolutional neural network may be used. The convolutional neural network is typically fed one radar image at a time, and feature extraction is performed by the neural network itself. Alternatively, the analytical model 41 may be a recurrent convolutional neural network configured to analyze a series of images over time, and analyze relationships between candidate objects in a current radar image and candidate objects in radar images from prior time steps. With such a recurrent convolutional neural network, time-dependent features such as the pulsing intensity of echo signals may be extracted as features by the recurrent neural network itself. As another alternative, a non-recurrent convolutional neural network may be fed two or more images taken at two or more respective timesteps in a series. In this way, the convolutional neural network may analyze relationships between the intensity in echo signals in the different images, without the complexity of training a recurrent convolutional neural network. As yet another alternative, to simplify the training of the convolutional neural network, feature descriptors such as scale invariant feature transforms (SIFT) may be defined by the user in the input layer, instead of solely inputting pixel values from regions of interest in the radar image. The learning module 124b may learn in the radar image 51 where the various target objects actually exist, including flocks of birds, based on the correct answer information, and build the analytical model 41. For example, the learning module 124b sequentially reads the radar image 51 in the memory part 123, cuts a partial image indicative of the echo image of each target object from the radar image 51, and inputs the partial images into the analytical model 41. Then, the learning module 124b may acquire, as an output of the analytical model 41, information indicative of the type of each target object indicated by the inputted partial image, and update a parameter of the analytical model 41 so that the information indicative of the type of each target object corresponds with the correct answer information. Here, the parameters that are adjusted during training are, for example, various coefficients which define the convolutional neural network as the analytical model 41. The analytical model 41 may be optimized while being applied with the teacher data one after another. Since various learning methods for supervised learning using a neural network are known, a detailed description thereof is herein omitted; however, it will be appreciated that a backpropagation algorithm may be used. As described above, once the learning process is completed, the analytical model 41 is then derived. The derived analytical model 41 may be stored in the memory part 23 of the radar indicator 20.

### <2-2-2. Details of Flow of Bird Detection Processing>

The bird detection processing of this embodiment is executed when the bird mode is selected in the radar indicator 20. When the radar image 51 in the bird mode is generated, first, the bird detecting module 31b may sequentially cut the partial image indicative of the echo image of each target object indicated in the radar image 51. Further, the bird detecting module 31b may sequentially input these partial images into the analytical model 41, and acquire the information indicative of the types of the target objects indicated in the inputted partial images as the output of the analytical model 41. Then, the bird detecting module 31b may sequentially determine whether each target object indicated in the partial image is a flock of birds based on the output.

If the bird detecting module 31b determines that the target object indicated in the partial image is not a flock of birds, it may then continuously perform a similar processing to the next partial image or radar image 51. On the other hand, if the bird detecting module 31b determines that the target object indicated in the partial image is a flock of birds (i.e., if a flock of birds is detected in the partial image), a tracking processing to track the flock of birds may be performed as illustrated in FIG. 9. In this embodiment, the detection of the flock of birds based on the output of the analytical model 41 before starting the tracking processing may correspond to a “temporary” detection. In this embodiment, the tracking processing may be executed in response to the “temporary” detection in order to prevent a false detection of the flock of birds, and when the tracking of the flock of birds in the tracking processing continuously succeeds, a final judgment that the flock of birds exists will be made. In this embodiment, information indicating that the flock of birds exists may be outputted in response to the final judgment. Here, even if the user wants to catch a school of fish below the flock of birds which is detected at the opposite side or the other side of land from the ship, it may not be certain whether the ship can reach there in the first place. Therefore, when an echo of a target object is determined to be land, the bird detecting module 31b may skip an input to the analytical model 41 of the partial image which is located farther than the echo of the land from the ship. Thus, the bird detection processing to the other side of land can be omitted, resulting in reducing the calculation load. Note that the judgment of whether the echo is from land may be performed using a conventionally-known technique, and for example, the judgment may be made based on the magnitude of the echo.

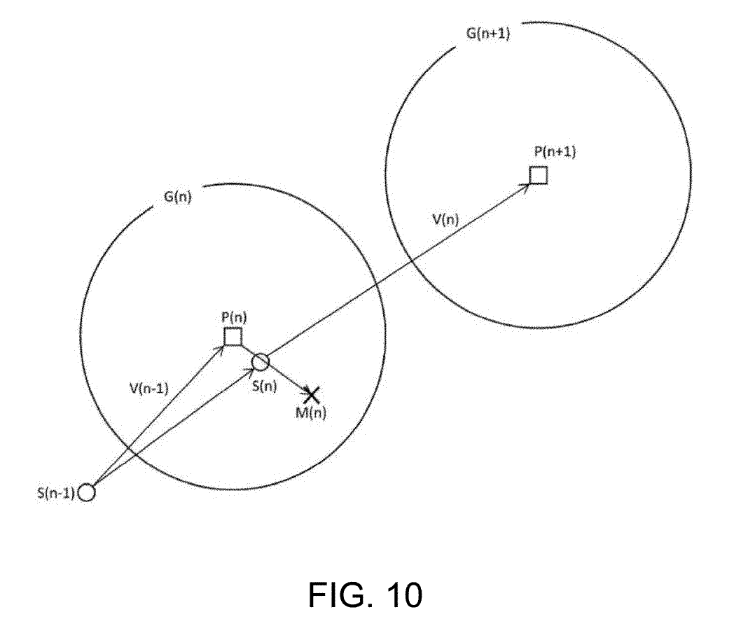

In the tracking processing of this embodiment, tracking by using a tracking filter, more specifically a αβ filter, may be performed. FIG. 10 is a conceptual view illustrating the tracking processing with the αβ tracking filter, where a linear predictor with a location smoothing constant α and a speed smoothing constant β predicts from the n-th scan to the (n+1)th scan. Here, P(n) is a predicted location, M(n) is a measured location, S(n) is a smoothed location, V(n) is a smoothed speed, E(n) is a tracking error, G(n) is a prediction gate, and T is a sampling period. Note that “n” in a parenthesis represents a timing of the scan. Here, the predicted location P(n+1) at the (n+1)th scan may be calculated by the following formulas.

E(n)=M(n)−P(n)

S(n)=P(n)+αE(n)

V(n)=V(n−1)+βE(n)/T

P(n+1)=S(n)+V(n)T

The tracking processing of FIG. 9 will now be described in detail. As described above, this tracking processing may be started each time the temporary detection of a flock of birds is performed, in order to track the flock of birds. Here, at Step S1, the bird tracking module 31c may set the location (coordinates) of the temporarily-detected flock of birds as a measured location M(1), and then derive a predicted location P(2) in the next scan based on the measured location M(1). More specifically, a predicted location P(1) and a smoothed location (51) when the tracking begins (i.e., when n=1) are equal to the measured location M(1), and an initial value V(1) of the smoothed speed is defined beforehand. Then, the predicted location P(2) in the next scan is derived based on the smoothed location S(1) and the initial value V(1) of the smoothed speed.

At subsequent Step S2, the bird tracking module 31c may set a prediction gate G(n) based on the derived predicted location P(n). Then, the radar image 51 in the bird mode in the n-th scan may be acquired, and an image T2 of a flocks of birds is searched within the prediction gate G(n) (in other words, the flock of birds is tracked). More specifically, the partial images indicative of the echo images of the target objects may be cut from an area within the prediction gate G(n) on the radar image 51 in the n-th scan. Further, the bird tracking module 31c may input the partial images into the analytical model 41, and then acquire information indicative of the types of target objects indicated in the inputted partial image as the output of the analytical model 41. The bird tracking module 31c may then determine whether the target object indicated in the partial image is a flock of birds based on the output. As a result, if a flock of birds is detected, the bird tracking module 31c may determine that the tracking of the flock of birds is successful (Step S3), and then transits to Step S4. At Step S4, the location (coordinates) of the flock of birds detected on the radar image 51 in the current scan may be set as the measured location M(n), and the predicted location P(n+1) in the next scan may be derived based on the measured location M(n).

On the other hand, at Step S2, if the partial image indicative of the echo image of the target object cannot be cut from the area within the prediction gate G(n) on the radar image 51 in the n-th scan, or if the partial image can be cut but there is no partial image determined to be a flock of birds, the bird tracking module 31c may determine that the tracking of the flock of birds is failed (Step S3), and then transit to Step S6. At Step S6, the predicted location P(n+1) in the next scan may be derived based on the location (coordinates) of the flock of birds detected at the last.

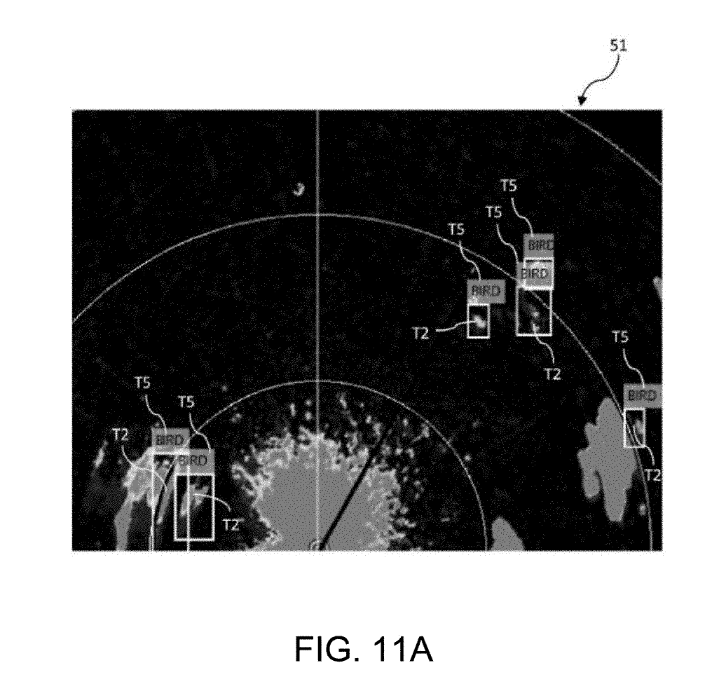

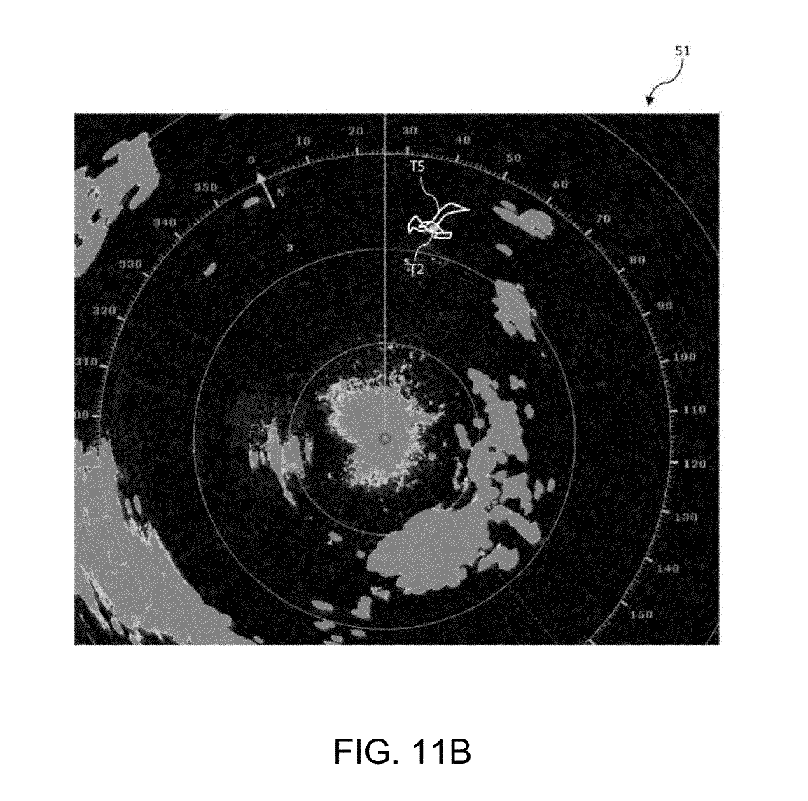

As illustrated in the flowchart of FIG. 9, if the tracking of a flock of birds at Step S3 continuously succeeds I times (I is an integer equal to or greater than 2), the information outputting module 31d may output information indicative of the existence of the flock of birds (Step S5). Note that the phrase “the tracking continuously succeeds I times” as used herein refers to that the tracking at Step S3 may successively or intermittently succeed I times before the tracking at Step S3 successively or intermittently fails J times (J is an integer equal to or greater than 2). The output of the information outputting module 31d may be variously performed, and in this embodiment, while the information indicative of the existence of the flock of birds is displayed on the display part 21, a sound such as an alarm sound which reports that the flock of birds is discovered through a speaker, etc., (not illustrated) may be outputted. FIGS. 11A and 11B illustrate examples of the display screen which displays the information indicative of the existence of the flock of birds. Thus, a given symbol T5 can be displayed near or over the echo image detected as the image T2 of a flock of birds on the radar image 51 in the bird mode. In the example of FIG. 11A, the symbol T5 is a box surrounding the echo image detected as the image T2 of the flock of birds, and in the example of FIG. 11B, the symbol T5 is an icon displayed so as to be superimposed on the echo image detected as the image T2 of the flock of birds. The symbol T5 may desirably be displayed using a different color from other areas on the radar image 51 and/or blinking, in order to exaggerate the existence of the flock of birds. The color of the symbol T5 may be changed while being displayed.

At Step S5, a text message expressing that the flock of birds is detected may also be displayed in addition to the symbol T5. Moreover, in the above processing, since the moving speed V(n) of the flock of birds is calculated, a vector symbol representing the speed and direction of the flock of birds may also be displayed in addition to or instead of the symbol T5.

When the information indicating that the flock of birds exists is outputted, the tracking processing of FIG. 9 may be ended. On the other hand, also when the tracking of the flock of birds does not continuously succeed I times, it may be determined that the flock of birds broke off, and the tracking processing of FIG. 9 may be ended.

By the above tracking processing, a confirmation of whether the flock of birds really exists may be made after the “temporary” detection of the flock of birds based on the analytical model 41. That is, in the above tracking processing, the past detection results of the flock of birds and the latest detection result of the flock of birds may be averaged in time. Therefore, even if a flock of birds is detected based on the analytical model 41, it will not be finally detected as a flock of birds because of the time average, if the probability of occurrence is low. Moreover, although a flock of birds exists, and even when the flock of birds could not be detected I or fewer times due to the omission in detection, etc., the tracking can be continued without missing the flock of birds. Therefore, a false detection of the flock of birds may be prevented to improve the detection accuracy of the flock of birds. Moreover, the bird tracking module 31c may skip the tracking processing of a flock of birds temporarily detected by the bird detecting module 31b in an area located farther than an echo of a target object determined as land, from the ship. Thus, the bird tracking processing for the other side of land can be omitted to reduce the calculation load.

Note that, if it is finally determined that the flock of birds exists and the tracking processing of FIG. 9 is completed through Step S5, the same flock of birds can still be continuously tracked. For example, the bird tracking module 31c may continue tracking of the flock of birds in a similar way to Steps S2-S4 and S6, and continue displaying the symbol T5 at the location of or near the latest images T2 of the flock of birds, unless the tracking fails. On the other hand, if the tracking fails, the symbol T5 may be eliminated from the radar image 51.

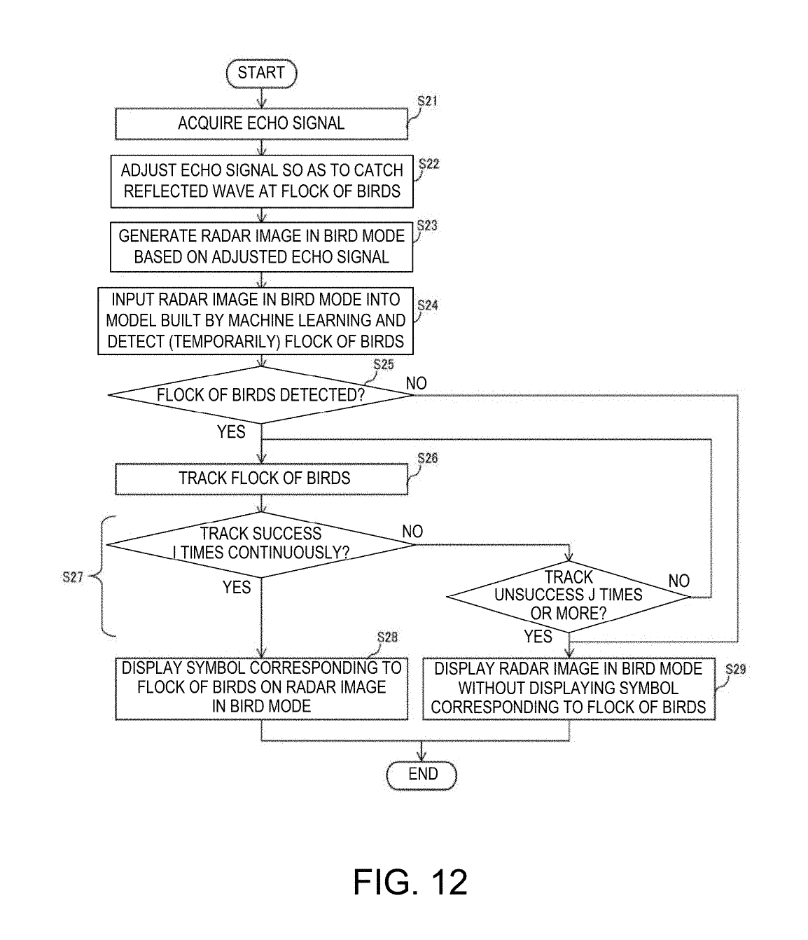

FIG. 12 is a flowchart which summarizes the already-described series of processings until the existence of the flock of birds is displayed on the radar image 51. As illustrated in this figure, the echo signal may be first acquired through the radar interface part 25 (Step S21). The screen generating module 31a may then adjust the acquired echo signal so that the reflected wave at the flock of birds can be caught (Step S22), and the radar image 51 in the bird mode may be generated based on the adjusted echo signal (Step S23). Next, the bird detecting module 31b may input the radar image 51 into the analytical model 41, and the temporary detection of the flock of birds may be performed (Step S24). If the flock of birds is temporarily detected (Step S25), the bird tracking module 31c may track the flock of birds (Step S26), and if the flock of birds is not temporarily detected (Step S25), the screen generating module 31a may display the radar image 51 in the normal bird mode (Step S29). On the other hand, if the tracking of the flock of birds continuously succeeds (Step S27), the screen generating module 31a may display the radar image 51 in the normal bird mode, and the information outputting module 31d may display the symbol T5 corresponding to the flock of birds over the radar image 51 (Step S28).

### <3. Features>

Although the radar image 51 in the normal mode can capture a flock of birds depending on the adjustment of sensitivity, the user may overlook the echo image based on the flock of birds because the echo signal of the flock of birds is weak. In this regard, since the radar image 51 in the bird mode can capture the image T2 of the flock of birds comparatively clearly, it is useful. However, for example, a user of a pleasure boat seldom uses the bird tracking function, and the image T2 of the flock of birds does not appear so frequently, either. Therefore, even if the image T2 of the flock of birds appears on the radar image 51, it may be difficult for this type of user who is not used to recognize the image T2 to be a flock of birds. Moreover, for a safe cruise, the user may not focus only on the existence of the flock of birds by always watching the radar image 51. In this regards, according to the bird detection processing of this embodiment, the flock of birds may be automatically detected and the detection result may be outputted intelligibly for the user. In addition, since the flock of birds is detected with high precision by using a model trained by machine learning and the tracking processing, the user may discover the flock of birds easily and accurately.

### <4. Modifications>

As described above, although one embodiment of the present disclosure is described, the present disclosure is not limited to the above embodiment and various changes may be possible without departing from the subject matters of the present disclosure. For example, the following changes may be possible. Note that the following modifications may suitably be combined.

<4-1>

Although the bird detection processing of the above embodiment is applied to the ship radar device 1, it is also similarly applicable to other detecting devices, such as radars for weather and aviation, a fish finder, and sonar.

<4-2>

In the above embodiment, the example in which birds are detected based on the analytical model 41 is illustrated. However, based on the output of the analytical model 41, the analytical model 41 may be built so that at least one of a school of fish, a rock, a current rip, ice, rain, clouds, and SART may be detected, instead of or in addition to the birds. Note that the function for detecting the school of fish may desirably be mounted on an apparatus, such as the fish finder and sonar. Moreover, as the function for detecting the school of fish, the analytical model 41 may also be built so that the fish types, such as sardine and tuna, can be distinguished based on the output of the analytical model 41. Moreover, the function for detecting ice may desirably be mounted on an apparatus mounted on a ship which cruises the Arctic Ocean etc.

Moreover, although in the above embodiment the echo signals when various target objects, such as, in addition to the flocks of birds, other ships, rocks, current rips, ice, rain, clouds, and SART, exist are used as the teacher data for learning of the analytical model 41, the analytical model 41 may also learn with teacher data only including the echo signals when the flocks of birds exist.

<4-3>

Although the αβ filter is used in the tracking processing of the above embodiment, other filters, such as a αβγ tracking filter and a Kalman filter, can of course be used.

<4-4>

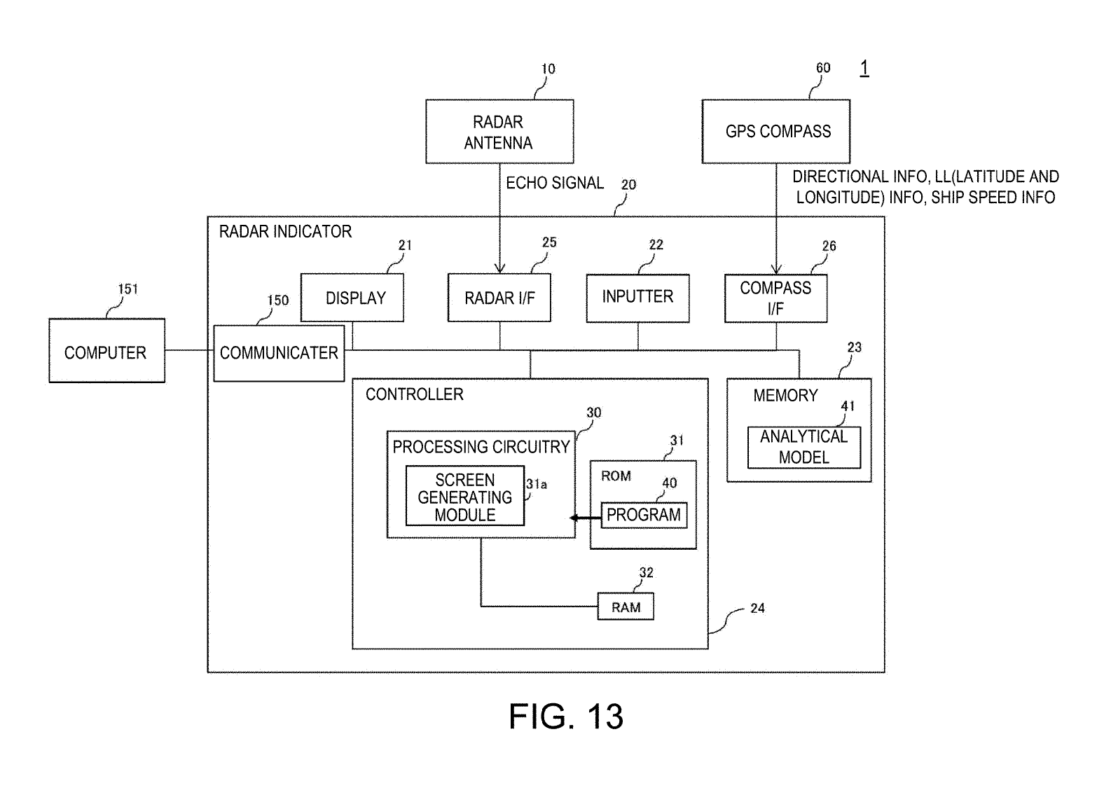

In the above embodiment, the bird detection processing may be executed by the radar indicator 20. However, as illustrated in FIG. 13, the bird detection processing may also be performed in an external device 151 which wiredly or wirelessly connected with the radar indicator 20 (e.g., it may be a computer or a cloud server). In this case, the echo signals inputted into the radar indicator 20 from the radar antenna 10 (and the directional information, the LL information, and the ship speed acquired from the GPS compasses 60), or the radar image 51 generated by the screen generating module 31a may be outputted to the external device 151 through a communication part 150 of the radar indicator 20, and the external device 151 may execute the above processings of the bird detecting module 31b, the bird tracking module 31c, and the information outputting module 31d.

<4-5>

Although in the above embodiment the directional information and the LL information are acquired using the GPS compass 60, similar information may also be acquired using a magnetic compass, a gyrocompass, or a GPS sensor.

<4-6>

In the above embodiment, the bird detecting module 31b may calculate the accuracy of the final detection of the flock of birds. In this case, the information indicative of the existence of the flock of birds may be outputted only when the accuracy of the detection exceeds a given threshold. Further, the user may then adjust the threshold. The accuracy of the detection may be determined based on, for example, the output value from the analytical model 41 (in this case, the analytical model 41 learns beforehand so as to output a value corresponding to the probability of the target object indicated in the inputted image being a flock of birds), and the probability of succeeding in the tracking processing at Step S3.

<4-7>

Although in this embodiment the bird detection processing is executed when the bird mode is selected in the radar indicator 20, the bird detection processing may also be executed when the bird mode is not selected. For example, when the user commanded an execution of the bird detection processing through the input part 22, the radar image 51 in the bird mode is internally generated without being displayed on the display part 21, and the detection of the flock of birds is executed based on the radar image 51. Then, when the flock of birds is finally detected, audio or a message expressing the final detection may be outputted. In this case, the symbol of the flock of birds may also be displayed over the radar image 51 in the normal mode.

<4-8>

Although in this embodiment the bird tracking module 31c cuts the partial image for every scan up to the n-th scan, and detects and tracks the flock of birds based on the analytical model 41, the detection of the flock of birds based on the analytical model 41 may be executed only when the tracking begins (i.e., when n=1). In this case, the bird tracking module 31c may track the echo image from which the flock of birds is detected for the first time (i.e., when n=1) by the conventional TT (Target Tracking), and then determine the success or failure of tracking of the flock of birds by determining whether the location of the tracked echo image is located within the area of the prediction gate G(n) in the subsequent scan (n).

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controlling module, microcontrolling module, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controlling module, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow views described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

It should be emphasized that many variations and modifications may be made to the above-described embodiments, the elements of which are to be understood as being among other acceptable examples. All such modifications and variations are intended to be included herein within the scope of this disclosure and protected by the following claims.

### DESCRIPTION OF REFERENCE CHARACTERS

1 Radar Device
10 Radar Antenna
20 Radar Indicator (Computer)
21 Display Part
23 Memory Part
25 Radar Interface Part (Acquisition Part)
31a Screen Generating Module (Generation Part)
31b Bird Detecting Module (Detecting Part)
31c Bird Tracking Module (Tracking Part)
31d Information Outputting Module (Information Output Part, Output Part)
40 Program (Target Object Detection Program)
41 Analytical Model (Model)
50 Radar Screen
51 Radar Image
60 GPS Compass
101 Learning Device
124 Control Part
124a Screen Generating Module
124b Learning Module (Learning Part)
125 Communication Part (Acquisition Part)
T1 Image of Other Ships
T2 Image of Flock of Birds
T4 Echo Trail
T5 Symbol

1. A target object detecting device, comprising:
a radar interface configured to acquire echo signals from target objects around a ship; and
processing circuitry configured to:
generate a first echo image based on the echo signals, and
input the first echo image into a model built by a program that implements a machine learning algorithm, and detect a first target object that is a target object other than a ship corresponding to the model, based on an output from the model.

2. The target object detecting device of claim 1, wherein
the first target object includes a bird.

3. The target object detecting device of claim 1, wherein
the first target object includes at least one selected from the group consisting of a school of fish, a rock, a current rip, ice, rain, clouds, and SART.

4. The target object detecting device of claim 1, wherein
the processing circuitry adjusts the echo signals so that a reflected wave at the first target object weaker than a reflected wave at a ship is caught, and generates the first echo image based on the adjusted echo signals.

5. The target object detecting device of claim 2, wherein
the processing circuitry adjusts the echo signals so that a reflected wave at the first target object weaker than a reflected wave at a ship is caught, and generates the first echo image based on the adjusted echo signals.

6. The target object detecting device of claim 1, wherein
the processing circuitry further generates a second echo image in which noise is less than the first echo image, and an image of a ship is indicated more clearly, based on the echo signals.

7. The target object detecting device of claim 5, wherein
the processing circuitry further generates a second echo image in which noise is less than the first echo image, and an image of a ship is indicated more clearly, based on the echo signals.

8. The target object detecting device of claim 6, wherein
the processing circuitry generates the first echo image by adjusting the echo signals so that at least one of raising a gain more than when generating the second echo image, lowering a level of removal of sea surface reflections, and lowering a level of removal of rain and snow clutter is performed.

9. The target object detecting device of claim 7, wherein
the processing circuitry generates the first echo image by adjusting the echo signals so that at least one of raising a gain more than when generating the second echo image, lowering a level of removal of sea surface reflections, and lowering a level of removal of rain and snow clutter is performed.

10. The target object detecting device of claim 6, wherein
the processing circuitry displays a symbol corresponding to the detected first target object over the second echo image.

11. The target object detecting device of claim 1, wherein
the processing circuitry displays a symbol corresponding to the detected first target object over the first echo image.

12. The target object detecting device of claim 1, wherein
the first echo image is a true echo trail image.

13. The target object detecting device of claim 1, wherein
the processing circuitry tracks a location of the detected first target object using a tracking filter.

14. The target object detecting device of claim 10, wherein
the processing circuitry outputs information indicating that the first target object exists, when the processing circuitry continuously succeeds in the tracking of the first target object.

15. The target object detecting device of claim 1, wherein
the model is a neural network.

16. The target object detecting device of claim 1, further comprising a radar antenna configured to receive the echo signals.

17. A method of detecting a target object, comprising:
acquiring echo signals of target objects around a ship;
generating a first echo image based on the echo signals; and
inputting the first echo image into a model built by a program that implements a machine learning algorithm, and detecting a first target object that is a target object other than a ship corresponding to the model, based on an output from the model.

18. A computer readable medium configured to store a computer executable program in a non-transitory manner, which upon execution by a processor of a computer causes the computer to authenticate a control device, by performing steps comprising:
causing a computer to acquire echo signals from target objects around a ship;
causing a computer to generate a first echo image based on the echo signals; and
causing a computer to input the first echo image into a model built by a program implementing a machine learning algorithm, and detect a first target object that is a target object other than a ship corresponding to the model, based on an output from the model.
